(19) United States
(12) Patent Application Publication
(10) Pub. No.: US 2016/0337878 A1
(43) Pub. Date: Nov. 17, 2016

(54) IMPROVING NETWORK EFFICIENCY

(71) Applicant: NOKIA SOLUTIONS AND NETWORKS OY, Espoo (FI)

(72) Inventors: Frank Frederiksen, Klarup (DK); Esa Tapani Tiirola, Kempele (FI)

(21) Appl. No.: 15/111,439

(22) PCT Filed: Jan. 15, 2014
(86) PCT No.: PCT/EP2014/050640

§ 371 Date: Jul. 13, 2016

(51) Int. Cl. H04W 24/02; H04W 72/12

(52) U.S. Cl. CPC H04W 24/02; H04W 72/1278; H04W 84/20

(57) ABSTRACT

There is provided a method, comprising: detecting, by a control node, which of the plurality of network nodes of a centrally coordinated network is currently serving as a master node, wherein the master node coordinates scheduling for one or more slave nodes in the network; identifying that one of the one or more slave nodes should be selected as the new master node on the basis of a predetermined selection criterion; and causing the identified slave node to serve as the new master node.

### FIELD OF THE INVENTION

The invention relates generally to improving network efficiency.

### BACKGROUND

It is important that communication networks work in an efficient manner so that the end users enjoy fast and reliable data services. As one example, in local area networks comprising multiple access points (AP), this may mean that data transfers (such as uplink and downlink phases in case of time division duplexing, TDD) are allocated in a coordinated manner to minimize mutual interference between transmitters and receivers within the collaboration area having many APs.

### BRIEF DESCRIPTION OF THE INVENTION

According to an aspect of the invention, there is provided a method as specified in claim 1.

According to an aspect of the invention, there is provided an apparatus as specified in claim 11.

According to an aspect of the invention, there is provided a computer program product as specified in claim 21.

According to an aspect of the invention, there is provided a computer-readable distribution medium carrying the above-mentioned computer program product.

According to an aspect of the invention, there is provided an apparatus, comprising processing means configured to cause the apparatus to perform any of the embodiments as described in the appended claims.

According to an aspect of the invention, there is provided an apparatus comprising means for performing any of the embodiments as described in the appended claims.

Embodiments of the invention are defined in the dependent claims.

### LIST OF THE DRAWINGS

In the following, the invention will be described in greater detail with reference to the embodiments and the accompanying drawings, in which

FIGS. 1, 2A and 2B present some network layouts, according to some embodiments;

FIG. 3 shows a method, according to an embodiment;

FIG. 4 shows how the proposal may affect the master node configuration in the network, according to an embodiment;

FIG. 5 illustrates how a control node may gather traffic information, according to an embodiment;

FIG. 6 depicts how the type of the network node is indicated in the network, according to an embodiment;

FIG. 7 illustrates transmission of scheduling information in the network, according to an embodiment;

FIGS. 8A and 8B illustrate recovery process in case current master node disappears, according to an embodiment; and

FIG. 9 illustrates an apparatus, according to an embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio system, such as in at least one of the following: Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and/or 5G system. Typically a communication network comprises base stations, also known as an access point, a node B (NB) or an evolved node B (eNB), capable of controlling radio communication and managing radio resources within a corresponding cell. Further, the eNB may establish a connection with user equipment (UEs), such as a mobile user terminal (UT) or any other apparatus capable of operating in a mobile communication network.

As said, a local area network may comprise many base stations, or local area access points (AP). Such APs may be employed, e.g. for small cell enterprise solutions. An example of an AP may be a femto nodeB. In such local area networks, a coordinated manner of allocating resources may be needed to minimize mutual interference between transmitters and receivers within the collaboration area having many APs.

A local area system can be deployed either in a standalone or in a centrally coordinated manner (or in any combination of those). A standalone local area system may be characterized so that all APs in the network operate independently of each other. However, a centralized (or a coordinated) local area operation may assume that there is some kind of central controlling element in the system (also denoted here as a master node or a master AP—in other implementations there could be alternative naming conventions). The other APs may then be coordinated by this wireless controlling element. The controlling element/entity may communicate with the other APs which may provide a scalable centralized control plane to the LA wireless network. The controller functionality may be physically located in one of the existing APs, for example.

Although described so that the embodiments are usable in the local area scenario, the embodiments may as well be described in any system or network implementing a centrally coordinated wireless communication among multiple APs.

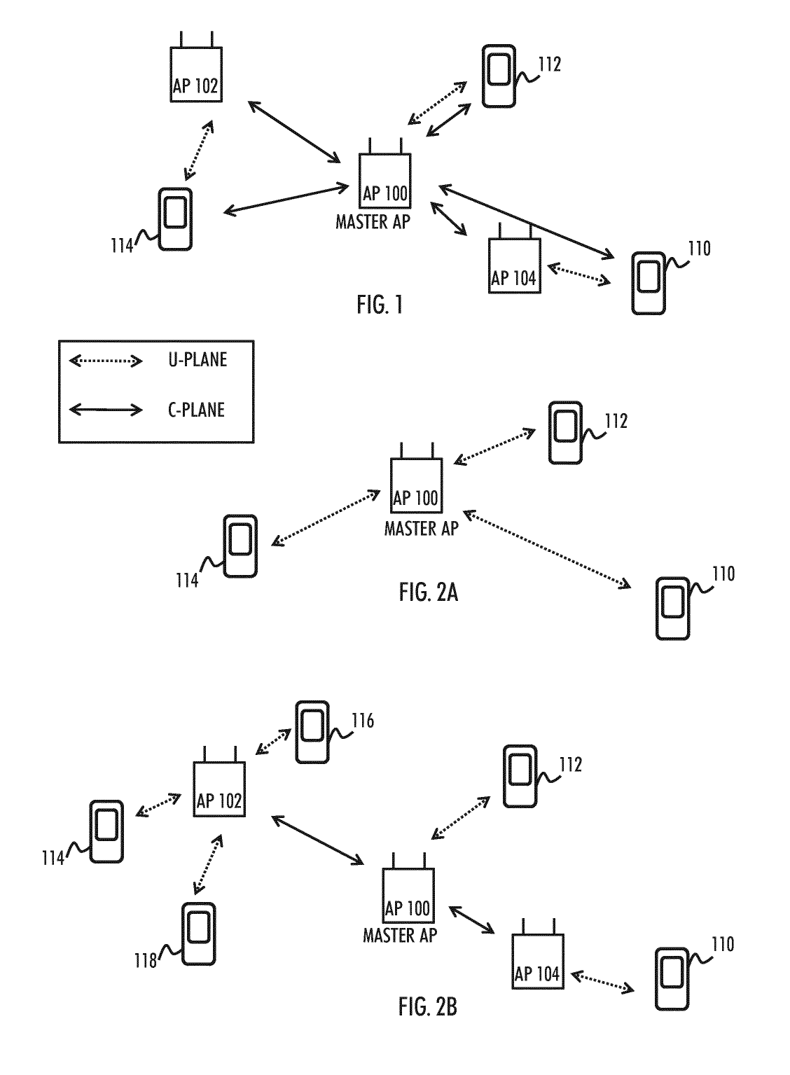

FIG. 1 shows an example of a scenario where the controlling of the APs 100, 102, 104 takes place. Let us assume that the AP 100 is the master AP. Then, in FIG. 1, both the slave APs 102, 104 and the UEs 110-114 may be able to wirelessly receive (or transmit) scheduling information transmitted (or received) by the master AP 100. It should be noted that the control messages from the master AP 100 to the slave APs 102, 104 may also be transferred by using wired communication (for instance over standardized interfaces). In the Figures, a dotted arrow represents user plane (user data) communication whereas a solid arrow denotes control plane (control data) communication. Although not shown, there may be control data transferred between any AP and any UE, or there may be user data transferred between any APs.

It may be that the master AP 100 is selected at deployment of the network and the master AP 100 may remain being in control for the remainder of the existence of the deployed system (or until a manual reconfiguration is applied). In an embodiment, the selection criterion for initial selection of the master AP 100 may be based on one or more of the following parameters: first node (i.e. AP) deployed, node with the most processing power, node with the highest capacity in control plane interface, node with highest amount of expected traffic, for example.

FIGS. 2A and 2B show a simplified illustration of a network deployment. In FIG. 2A there is only one AP 100 which may act as the master node (since it is the only node with a connection to the backbone network). The AP 100 may be communicating with three UEs 110-114. However, as shown in FIG. 2B, at a later point in time, a number of new network access nodes 102 and 104 are installed in the network (e.g. in order to address coverage problems and/or because these additional nodes 102 and 104 are switched on). However, as further shown in FIG. 2B, the traffic distribution may have changed such that one of the slave nodes, namely the AP 102, is carrying more traffic (either in the sense of more bits per second being transferred or in the sense of serving more UEs at the same time) than the current master node 100. Nevertheless, the node 100 may continue to serve as the master node.

In this kind of scenario, it may be inefficient to keep the node 100, which is handling relatively low amount of traffic, as the master node. This may be because the master node may typically be able to perform/manage network coordination mechanism so as to avoid interference coordination or in order to perform coordinated scheduling actions. The effects and management of such mechanisms may be improved if the mechanisms are handled by a node having the most knowledge of the network situation. Naturally information may be shared between the APs 100-104 so that the master node could in principle be any of the APs 100-104. However, as there are inevitable signalling delays between the APs 100-104 in the system, another solution may be needed.

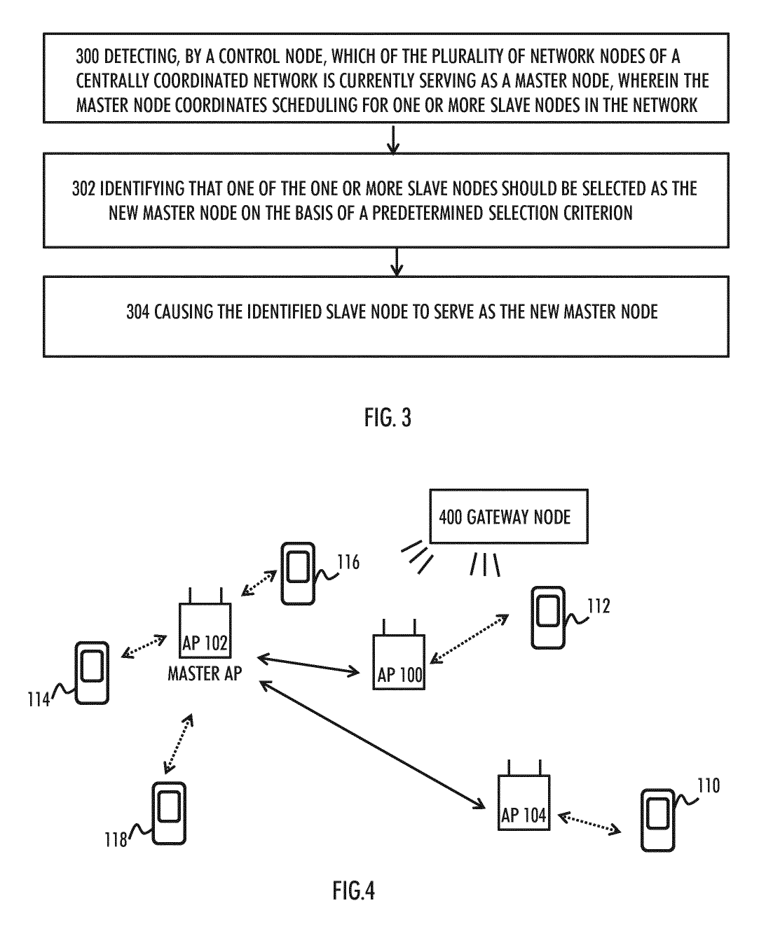

Accordingly, there is provided a solution for dynamically adapting the network layout to the traffic needs so that the master node functionality is dynamically located at the network access node of the network where the most traffic (according to a predefined criterion) is located/transferred. In order to reach this, it is proposed, as shown in FIG. 3, that a control node may, in step 300, detect which of the plurality of network nodes 100-104 of a centrally coordinated network is currently serving as the master node. As indicated above, the master node coordinates scheduling for one or more slave nodes in the network. In an embodiment, there is a plurality of slave nodes in the network. Let us assume that the current master node (master AP) is the AP 100, as shown in FIGS. 2A and 2B.

The control node which performs the method of FIG. 3 may be one of the plurality of network nodes 100-104 in the centrally coordinated network comprising one or more slave nodes and at least one master node. Therefore, in an embodiment, the control node may be the current master node. In an embodiment, the control node may be the AP 100. In another embodiment, the control node is one of the current slave nodes 102-104.

However, in one embodiment, the control node is a node locating higher in the hierarchy of the network than the slave or the master nodes. One example of the control node may be a gateway node 400 (shown in FIG. 4), which may unicast/multicast/broadcast data to other nodes 100-104. The gateway node 400 may have access to the backbone network and it may receive information from each of the APs under the coverage area of the gateway node 400. In an embodiment, the gateway node may handle data transfers related to the APs 100-104 to/from the backbone network.

The control node may comprise the functionality for controlling the node type of the network nodes 100-104. Therefore, the control node may change the node type/mode of a given node between a master node-mode and a slave node-mode. In an embodiment, all APs 100-104 can operate in both modes, i.e. in the master mode and in the slave mode. In an embodiment, the functionality of controlling the AP mode changes is located physically in one place, e.g. in the gateway node 400 or in any of the APs 100-104.

Let us now, before going deeper to FIG. 3, look at the roles of a master node and a slave node. Master and slave nodes may from conceptual point of view have different roles. Master nodes may, e.g. issue commands in order to control the slave nodes.

In an embodiment, the slave nodes are “dumb” in a sense that they may obtain at least some rules or policies from the master node, which the receiving slave nodes are required to follow when handling data traffic to any connected UE 110-118. One example of such a rule/policy may be a definition of a time-wise pattern which is to be applied when the slave node is making uplink (UL) and downlink (DL) scheduling decisions. Another example of a rule/policy may be a time-wise pattern defining which type(s) of UEs are allowed to be scheduled at which time(s), e.g. near or far UEs. The master node may define these rules/policies and the slave node may need to follow them.

A master node may be responsible for collecting data from other nodes, such as from slave nodes, or even statistics collected by the UEs in the network. The collected data may comprise, e.g. measurement information or associated statistics. The information or statistics obtained may comprise UL and DL traffic load, number of associated UEs to each slave node, UE measurements of neighbour nodes, for example. Based on these measurements, the master node may signal the rules/policies to the respective slave nodes. One example of a concept where such policies are applied may be an operational carrier selection (OCS) procedure, which is under consideration for interference control. For example, based on the collected data, the master node may gather a background interference matrix (BIM) that is then exchanged between the nodes 100-104 in order to allow the nodes 100-104 to calculate which carriers may be applied without causing severe interference to neighbouring APs.

Let us then take a look at FIG. 3 further. In step 302 the control node may identify that one of the slave nodes 102, 104 should be selected as the new master node on the basis of a predetermined selection criterion. Let us assume that the identified node is the slave node 102. Thereafter, in step 304, the control node may cause the identified slave node 102 to serve as the new master node as shown in FIG. 4, as contrast to FIG. 2B in which the node 100 continues to serve as the master node. It may be beneficial to be able to dynamically change the master node of the network or to dynamically add new master nodes to the network in order to improve network's capability to adapt to varying conditions and in order to improve network's capability to adapt to evolving network deployments (including varying number of network nodes).

Let us look closer at what the predetermined selection criterion may be. The predetermined selection criterion may comprise any given metric of benefit. The value of the metric may vary according to which network node 100-104 is selected as the master node. Therefore, the control node may determine on the basis of the metric of benefit which network node is most beneficial to be selected as the master node. If the identified network node 102 is different than the current master node 100, then the control node may decide to perform a change of a node type from the slave mode to the master mode at least for the identified node 102. The metric of benefit may represent efficiency of the network, for example. Thus, it may be determined which node should be selected as the master node from the point of view of the efficiency of the network. As understood by a skilled person, there may be many different metrics which may be used for this purpose. Let us take a look at some examples.

In an embodiment, the selection criterion requires that the identified slave node 102 is handling more traffic in the network than the current master node 100. As shown in FIG. 4, it may be that the AP 102 is handling traffic for three different UEs 114-118, whereas the current master AP 100 handles traffic only for the UE 112. In such case it may be wiser to define the slave node 102 as the new master node. This may be because then traffic information need not be transferred between the nodes as much as in a case where the node 102 continues to serve as the slave node. In an embodiment, the predetermined criterion is that the identified slave node 102 is handling the most traffic in the network among all network nodes 100-104.

In an embodiment, the amount of traffic may be determined as amount of bits transferred. For example, the identified slave node 102 may transfer more data in bits than the current master node 100, for example. In this case the identified node may not necessarily be the one that is associated with the largest number of UEs, but the one that is transferring largest amount of data, for example.

In another embodiment, the amount of traffic may be determined as number of user terminals served. In such case, it may be that the identified slave node 102 may serve more UEs than the current master node 100. In FIG. 4, the AP 102 serves three UEs whereas the APs 100 and 104 each serve only one UE. In an embodiment, the control node may detect the type of traffic being handled by each node. For example, one slave node may handle (e.g. transfer) more control data but less user data than the master node. In case the criterion requires that the identified slave node is handling more traffic of certain data type (e.g. control data) in the network than the current master node 100, the control node may identify that the master node functionality is to be handed over to the identified slave node. Instead of control data, any type of data may be taken into account with the selection criterion. These may include, e.g., best effort-data, user data, voice data, video data, high quality-of-service (QoS) data, to mention only a few possible non-limiting option.

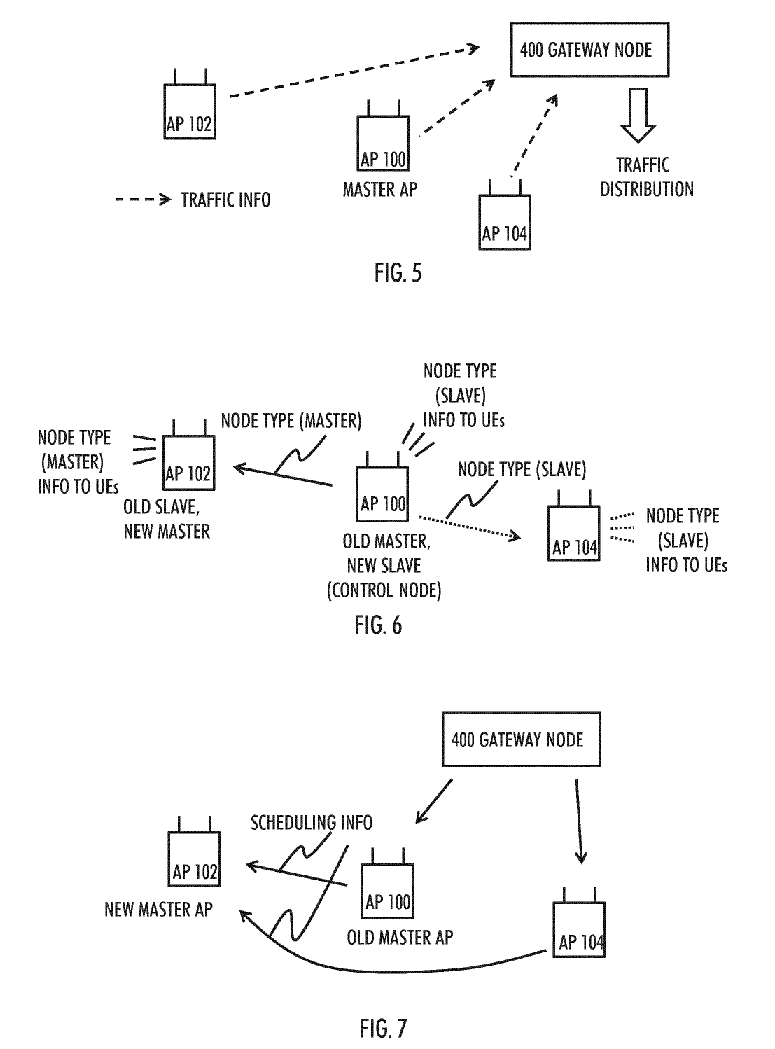

In order to be able to identify the node which would benefit the most from being the master node/AP, the control node may, in an embodiment, acquire traffic handling information from the plurality of network nodes 100-104. This is shown in FIG. 5, where it is assumed that the control node is the gateway node 400. That is, the gateway node 400 may collect relevant information from the nodes 100-104 that are operating within the scope of the gateway node 400. Alternatively, the control node may be any of the nodes 100-104. The traffic information may indicate how many UEs are being served by each AP 100-104 and/or what is the amount of data being handled (e.g. transferred to and/or from the connected UE(s)). Further, the traffic information may indicate the types of the data (e.g. user data, control data, QoS data, etc.) which is being handled by the nodes.

The traffic distribution information may be modified by the control node to take into account a scenario in which some APs are switched off for power saving, for example. It may be that an AP at the edge of the network cell may be switched off at some point to save energy. This may change the traffic distribution in the network and may thus affect the identification of the slave node which is to be assigned as the new master node. The control node may determine how the traffic distribution in the network would change if a given node is shut down and the traffic from that node is transferred to the next closest AP. The control node may then apply this modified traffic distribution information when identifying the slave node which would be best to serve as the new master node. The given node (the one that may be shut down at some point) may be a node which is most likely to be shut down on the basis of history information, for example. If the history information implies that not many users are typically located close to that AP, it may be beneficial, from the point of view of energy savings, to shut down the AP and redirect the small amount of traffic from that shut down AP to another AP. Such proactive management of dynamic network changes may be advantageous so that the master node changes need not be performed often.

Based on the collected information, the control node may then determine traffic distribution in the network with respect to the plurality of network nodes 100-104. The traffic distribution information may indicate how many UEs are associated to each AP 100-104, how much data each AP 100-104 in the network is handling, which types and how much of each type of data is being handled by each AP 100-104. The traffic distribution information may be used to determine which one of the nodes 100-104 should be selected as the master node according to the predetermined selection criterion.

In an embodiment, the selection criterion requires that the identified slave node 102 is operating under more secure power supply than the current master node 100. For example, if the current master node is running on batteries and there is a slave node operating on external power supply, then the control node may decide to change the master node functionality to this slave node with better power supply capacity so as to ensure that the master node does not switch off due to lack of power.

In an embodiment, the selection criterion requires that the identified slave node 102 has higher processing power capability than the current master node 100. For example, if the slave node 102 has a software license installed to improve the processing capability, then the control node 100 may decide turn this slave node into master node. As an example, some computer systems have extra processors installed, and by purchasing licenses the user can increase the processing power of the access points without installing extra hardware.

In yet one embodiment, the selection criterion requires that the identified slave node 102 has better connectivity to the backhaul internet. For example, if the current master node 100 has connectivity through a wireless network, and the slave node 102 has either better wireless access (e.g. stronger signal, higher capacity, etc.) to the internet or even a wired connection to the Internet, then the control node may decide that the identified slave node 102 should act as a master node.

There may also be many selection criteria which the control node considers when identifying the slave node to which the master node functionality should be assigned to. In such case it may be that from a point of view of a first selection criterion, the node 102 seems to be the most promising one to serve as the master node (such as most traffic is being handled in the network by the node 102), whereas from a point of view of a second selection criterion, the node 104 seems more promising (such as that the node 104 has wired connection to backbone whereas the node 102 has a wireless connection).

In such case, the control node may weigth these different criteria according to predetermined weighting factors in order to end up with one identified slave node. The weight factors may be emprically derived or based mathematical simulations so that optimal weight factors for different networks may be used. In an embodiment, the weight factor values are based on the importance of the corresponding selection criterion. The importance of a given selection criterion may be defined by the network operatoror by the user, for example. These predetermined weighting factors and criteria may be preconfigured to a memory of the control node and they may be dynamically adapted according current network needs by the network operator, for example.

In an embodiment, weight factor for the most important criterion may be given the highest value. In an embodiment, the weight factor for the traffic handling criterion is higher than any of the weight factors for the other criteria. In an embodiment, the weight factor for the traffic handling criterion is higher than the summed weight factor for the other criteria. However, in an embodiment, the weight factor for the traffic handling criterion is less than the summed weight factor for any two other criteria.

In an embodiment, the control node (e.g. the gateway node 400) may cause a transfer of master node functionality from the current master node 100 to the identified slave node 102, thereby causing the current master 100 node to serve as a slave node from a predefined point onwards. That is the identified node 102 is changed to serve as a master node, while the old master node 100 is changed to serve as a slave node. The handover of the functionality may take a predefined time after which the previous master node 100 serves in a slave mode. Having only one master node in the network may be beneficial for reasons of network configuration, for example. In an embodiment, where the control node is the old master node 100, the control node may hand the master role functionality over to the identified slave node 102, thereby changing own node type from master to slave. The node 100 may nevertheless continue to be the control node.

In another embodiment, the AP 100 may remain as a master node even if the identified node 102 also obtains the master node functionalities. This may be the case if it is allowed that there are many master nodes in the network. This may be called as a distributed control scenario.

In an embodiment, the current master node, as the control node, may trigger the master node change. In an embodiment, this may take place via a specific physical layer message which all UEs and slave APs may be able to listen. This may be advantageous as then the change may be simultaneously informed to each relevant node and UE within the coverage area of the current master node. The message may indicate that a change of the master node functionality takes place from the current master node (e.g. the transmitting node in case the control node is the current master node) to the identified slave node.

In an embodiment, the control node may indicate the change of the master node to the network nodes in the network. In an embodiment, a parameter indicating the node type/mode is transmitted from the control node to the APs of the network. This may be important so that each of the nodes 100-104 in the network become aware which AP(s) is/are now the master node(s).

In an embodiment, the control node may indicate a node type/mode to at least one network node 100-104 of the network. The node type may inform the receiving network node 102-104 whether the receiving network node is to serve as a master or as a slave. This is shown in FIG. 6, where it is assumed that the AP 100 is the control node. The informing may be made to each of the APs 100-104 in the network. Alternatively, the informing may be omitted to those APs whose mode/type does not change. It should be noted that the control node may be the gateway node 400, instead of the AP 100.

The APs 100-104 may then further indicate the respective node type to connected user terminals, as also shown in FIG. 6. In an embodiment, a parameter indicating the node type is introduced and conveyed from the APs 100-104 to the UEs 110-118. In an embodiment, the node type may be a cell-specific parameter and it may be signalled from the APs 100-104, and/or the control node (e.g. in case the control node is one of the APs 100-104), to the UEs 110-118 as part of system information, e.g. as part of a master information block (MIB) or as part of a system information block (SIB). The type of the serving AP 100-104 may have an impact on the control signals, reference signals and frame structures as well as measurements and UE reporting applied in the cell. Therefore, it may be beneficial that the UEs 110-118 are aware of the node type (master or slave) of the serving AP.

As shown in FIG. 7, the control node (e.g. the gateway node 400) may also indicate to the old master node 100 that it is to deliver predetermined scheduling information to the new master node 102. The control node may also configure the one or more slave nodes, such as the slave node 104, to provide the predetermined scheduling and coordination information to the new master node 102. Accordingly, the old master node 100 and the slave nodes 104 may transfer the required scheduling data to the new master node 102. The transmission of the scheduling information may be advantageous so that the new master node 102 does not have to spend time on building up information on the current network operation. The scheduling information may comprise coordination information, information on how the UL/DL phases are scheduled by the corresponding APs, etc.

In an embodiment, the transmission of information between the network nodes 100-104 may take place on standardized interfaces, such as the X2 application protocol (X2AP). The information sent between the APs 100-104 may comprise, e.g. the scheduling/coordination information, transferring master node functionality from one node to another, indicating the master node change to the involved APs in the network.

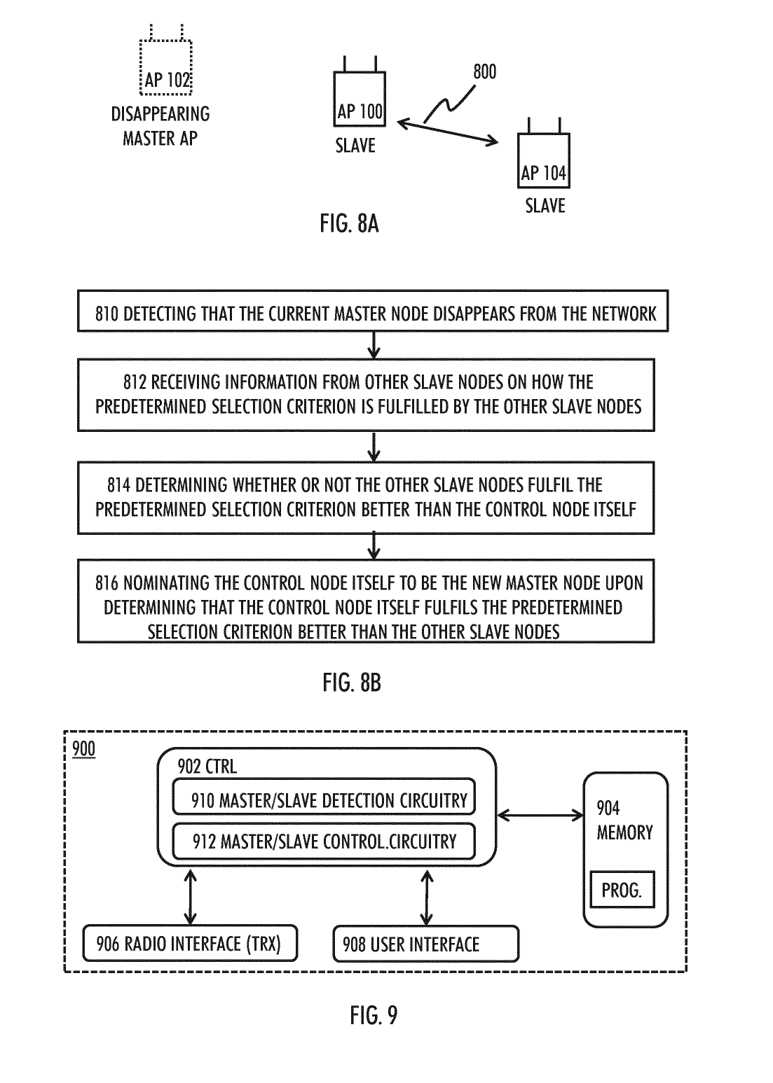

Let us, for the embodiments of FIGS. 8A and 8B, consider that the current master node is the AP 102, whereas the AP 100 has been changed into a slave mode. Let us further assume that the control node is one of the remaining APs, let us say the slave AP 100. In one embodiment, the control node (i.e. the AP 100) may in step 810 detect that the current master node 102 disappears from the network. This may take place due to the power of the AP 102 being switched off, due to the AP 102 moving to different area (in case of the AP 102 is a mobile AP) or due to the hardware failure, for example. The control node 100 may detect the disappearance of the AP 102 by losing a connection to the AP 102. In such case where the current master node 102 disappears, an automatic recovery procedure may need to take place in order to appoint a new master node to the network.

Consequently, the control node 100 may in step 812 receive information 800 from other slave nodes 104 on how the predetermined selection criterion is fulfilled by the other network nodes 104. The information 800 may comprise traffic handling related information, for example, or any information related to the used metric of benefit. Then, in step 814, the control node 100 may determine whether or not the other slave node 104 fulfils the predetermined selection criterion better than the control node 100 itself. Further, the control node 100 may in step 816 nominate itself to be the new master node upon determining that the slave node 100 itself fulfils the predetermined selection criterion better than the other slave nodes 104. However, upon detecting that the other slave node 104 fulfils the selection criterion better (e.g. the node 104 is handling more traffic than the AP 100), the control node 100 may remain in slave mode. The AP 104 may then be nominated as the new master node by the AP 100 (which is assumed to be the control node).

In an embodiment, after the master node 102 is detected to disappear from the network, the network may go into the standalone mode, in which all remaining APs in the network operate independently of each other without orders from the disappeared master node. This standalone mode may last at least until the control node 100 determines which of the remaining APs 100, 104 should be selected as the new master AP. This selection may be performed as disclosed with reference to steps 812-816.

The process of FIGS. 8A and 8B may also take place in a distributed control operation where there is no control node (e.g. the gateway node 400) in the network to make any centralized decision. By exchanging information of “master node benefits” between the remaining nodes 100, 102, one of the remaining nodes may nominate itself as the master node over the other nodes. By each node becoming aware of how well the other nodes fulfil the selection criterion, each node 100, 104 is able to determine should they appoint itself as the new master node or remain in the slave mode.

In an embodiment, the control functionality is implemented in a distributed manner in which case there is no centralized control node. In such case, each node may provide information to the current master node and possibly also gather information from the current master node. Thereafter, the current master node may make a decision to hand off its master role to one of the current slave nodes on the basis of the received information. The exchanged information may comprise, e.g. traffic information, scheduling information. The exchange of information may be implemented also as part of self-organizing network (SON) functionality, for example.

In one embodiment, there may be multiple master nodes in the network. Each of the master nodes may obtain information from one or more slave nodes. In an embodiment, there may be a centralized “super-master” node, which may handle the coordination of the master nodes.

In an embodiment, the control node may detect that there are currently a plurality of master nodes in the network. The control node may further identify that at least one of the one or more slave nodes should be selected as the master node on the basis of the predetermined selection criterion. The control node may then cause the least one identified slave node to serve as a new master node, instead of or in addition to the current master nodes.

As described, in order to reach the dynamic adaptation of the network layout due to dynamically varying conditions experienced in the network controlled by the master node, the proposal may include identifying which network node is the one that would benefit the most from being the master node/AP, and transferring of the master node's functionality from one node to another. Further, there may be automatic recovery in case the current master node disappears from the network (i.e. a recovery function). As such, the proposed framework may enable a dynamic adaptation of the network structure such that the scheduling and coordination efforts are performed in the most efficient way (e.g. with the least communication overhead) and/or benefit to the network operation.

An embodiment, as shown in FIG. 9, provides an apparatus 900 comprising a control circuitry (CTRL) 902, such as at least one processor, and at least one memory 904 including a computer program code (PROG), wherein the at least one memory 904 and the computer program code (PROG), are configured, with the at least one processor 902, to cause the apparatus 900 to carry out any one of the above-described processes. The memory 904 may be implemented using any suitable data storage technology, such as semiconductor based memory devices, flash memory, magnetic memory devices and systems, optical memory devices and systems, fixed memory and removable memory.

In an embodiment, the apparatus 900 may be or be comprised in an access point/node of a network. The access point may be also called a base station. In an embodiment the apparatus 900 is or is comprised in the control node.

The apparatus 900 may also comprise a user interface 906 comprising, for example, at least one keypad, a microphone, a touch display, a display, a speaker, etc. The user interface 906 may be used to control the apparatus 906 by the user.

The apparatus 900 may further comprise communication interface (TRX) 908 comprising hardware and/or software for realizing communication connectivity according to one or more communication protocols. The TRX 908 may provide the apparatus with communication capabilities to access the radio access network, for example.

The control circuitry 902 may comprise a master/slave detection circuitry 910 for detecting which node(s) of the network is/are master node(s) and which are slave nodes. A master/slave control circuitry 912 may be responsible for determining whether or not to change the type/mode of the any of the nodes 100-104 between the slave mode and the master node. The circuitry 912 may also define the selection criterion which is used in identifying whether one of the slave nodes should be changed into a master node.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
detecting, by a control node, which of a plurality of network nodes of a centrally coordinated network is currently serving as a current master node, wherein a master node coordinates scheduling for one or more slave nodes in the network;
identifying that one of the one or more slave nodes should be selected as a new master node on a basis of a predetermined selection criterion; and
causing the identified slave node to serve as the new master node.

2. The method of claim 1, further comprising:
causing a transfer of master node functionality from the current master node to the identified slave node, thereby causing the current master node to serve as a slave node from a predefined point onwards.

3. The method of claim 1, wherein the predetermined selection criterion is that the identified slave node is handling more traffic in the network than the current master node.

4. The method of claim 1, wherein the predetermined selection criterion is that the identified slave node is handling more traffic of a certain data type in the network than the current master node.

5. The method of claim 1, wherein the predetermined selection criterion requires at least one of the following: the identified slave node is operating under more secure power supply than the current master node, the identified slave node has higher processing power capability than the current master node, and the identified slave node has better connectivity to the backhaul internet.

6. The method of claim 1, further comprising:
acquiring traffic handling information from the plurality of network nodes; and
determining on the basis of the acquired information a traffic distribution in the network with respect to the plurality of network nodes.

7. The method of claim 1, further comprising:
indicating a node type to at least one network node of the network, wherein the node type informs a receiving network node whether the receiving network node is to serve as a master or as a slave in order to allow the network nodes to further indicate their own node type to connected user terminals.

8. The method of claim 1, further comprising:
indicating to the current master node that it is to deliver predetermined scheduling information to the new master node; and
indicating to the one or more slave nodes that they are to provide predetermined scheduling information to the new master node.

9. The method of claim 1, wherein the control node is a slave node, the method further comprising:
detecting that the current master node disappears from the network;
receiving information from other slave nodes on how the predetermined selection criterion is fulfilled by the other slave nodes;
determining whether or not the other slave nodes fulfil the predetermined selection criterion better than the control node itself; and
nominating the control node itself to be the new master node upon determining that the control node itself fulfils the predetermined selection criterion better than the other slave nodes.

10. The method of claim 1, wherein the control node is one of the plurality of network nodes in the centrally coordinated local area network comprising one or more slave nodes and at least one master node.

11. An apparatus, comprising:
at least one processor and at least one memory including a computer program code, wherein the at least one memory and the computer program code are configured, with the at least one processor, to cause the apparatus at least to:
detect which of a plurality of network nodes of a centrally coordinated network is currently serving as a current master node, wherein a master node coordinates scheduling for one or more slave nodes in the network;
identify that one of the one or more slave nodes should be selected as a new master node on a basis of a predetermined selection criterion; and
cause the identified slave node to serve as the new master node.

12. The apparatus of claim 11, wherein the at least one memory and the computer program code are configured, with the at least one processor, to cause the apparatus further to:
cause a transfer of master node functionality from the current master node to the identified slave node, thereby causing the current master node to serve as a slave node from a predefined point onwards.

13. The apparatus of any of claim 11, wherein the predetermined selection criterion is that the identified slave node is handling more traffic in the network than the current master node.

14. The apparatus of claim 11, wherein the predetermined selection criterion is that the identified slave node is handling more traffic of a certain data type in the network than the current master node.

15. The apparatus of claim 11, wherein the predetermined selection criterion requires at least one of the following: the identified slave node is operating under more secure power supply than the current master node, the identified slave node has higher processing power capability than the current master node, and the identified slave node has better connectivity to the backhaul internet.

16. The apparatus of any of claim 11, wherein the at least one memory and the computer program code are configured, with the at least one processor, to cause the apparatus further to:
acquire traffic handling information from the plurality of network nodes; and
determine on the basis of the acquired information a traffic distribution in the network with respect to the plurality of network nodes.

17. The apparatus of claim 11, wherein the at least one memory and the computer program code are configured, with the at least one processor, to cause the apparatus further to:
indicate a node type to at least one network node of the network, wherein the node type informs a receiving network node whether the receiving network node is to serve as a master or as a slave in order to allow the network nodes to further indicate their own node type to connected user terminals.

18. The apparatus of claim 11, wherein the at least one memory and the computer program code are configured, with the at least one processor, to cause the apparatus further to:
indicate to the current master node that it is to deliver predetermined scheduling information to the new master node; and
indicate to the one or more slave nodes that they are to provide predetermined scheduling information to the new master node.

19. The apparatus of claim 11, wherein the apparatus is comprised in a slave node, and wherein the at least one memory and the computer program code are configured, with the at least one processor, to cause the apparatus further to:
detect that the current master node disappears from the network;
receive information from other slave nodes on how the predetermined selection criterion is fulfilled by the other slave nodes;
determine whether or not the other slave nodes fulfil the predetermined selection criterion better than the slave node comprising the apparatus; and
nominate the slave node comprising the apparatus to be the new master node upon determining that the slave node comprising the apparatus fulfils the predetermined selection criterion better than the other slave nodes.

20. The apparatus of claim 11, wherein the apparatus is comprised in one of the plurality of network nodes in the centrally coordinated local area network comprising one or more slave nodes and at least one master node.

21. A computer program product embodied on a distribution medium readable by a computer and comprising program instructions which, when loaded into an apparatus, execute the method according to claim 1.
